(19) United States
(12) Patent Application Publication
(10) Pub. No.: US 2010/0013837 A1
(43) Pub. Date: Jan. 21, 2010

(54) Method And System For Controlling Character Animation

(75) Inventors: Liang Zeng, Shenzhen City (CN); Xiaozheng Jian, Shenzhen City (CN); Jinsong Su, Shenzhen City (CN); Zexiang Zhang, Shenzhen City (CN); Dongmai Yang, Shenzhen City (CN); Min Hu, Shenzhen City (CN); Xin Chang, Shenzhen City (CN)

Correspondence Address: HARNESS, DICKEY & PIERCE, P.L.C., P.O. BOX 828, BLOOMFIELD HILLS, MI, 48303, US

(73) Assignee: Tencent Technology (Shenzhen) Company Limited, Shenzhen City (CN)

(21) Appl. No.: 12/568,174

(22) Filed: Sep. 28, 2009

Related U.S. Application Data
(63) Continuation of application No. PCT/CN2008/070627, filed on Mar. 28, 2008.

(30) Foreign Application Priority Data
Mar. 28, 2007 (CN) 200710073717.9

(51) Int. Cl. G06T 13/00

(52) U.S. Cl. 345/473

(57) ABSTRACT

Embodiments of the present invention provide a method for controlling character animation, in which the character animation includes at least two bones and skins corresponding to the bones, the method includes: (a) dividing the character animation into at least two parts, and setting an identification number for each part; (b) establishing a mapping table comprising a corresponding relationship between the identification number and skin data of each part; (c) picking skin data of an operation focus location in the character animation; (d) querying the mapping table according to the skin data, obtaining a corresponding identification number, and controlling the part in the character animation corresponding to the identification number. Embodiments of the present invention also provide a system for controlling character animation. Different parts of the character animation may be picked respectively by dividing the character animation into multiple parts.

### CROSS-REFERENCE TO RELATED APPLICATIONS

This application is a continuation of International Application No. PCT/CN2008/070627 filed on Mar. 28, 2008. This application claims the benefit and priority of Chinese Application No. 200710073717.9 filed Mar. 28, 2007. The entire disclosures of each of the above applications are incorporated herein by reference.

### FIELD

The present disclosure relates to computer graphics technologies, and more particularly, to a method and system for controlling character animation.

### BACKGROUND

This section provides background information related to the present disclosure which is not necessarily prior art.

Character animation is an important constituent part of computer animation technologies, which always plays an important role in computer-assisted animated film production and various types of advertisement production. With the development of computer hardware technologies, especially with the development of consumption-level video card technologies with functions of hardware acceleration, real-time character animation accesses to an increasingly wide range of applications in a game. At present, the character animation is usually achieved by boned animation mode.

In boned animation, an animated character is denoted by two parts. One part is a series of bones forming level, e.g., skeleton, data of each bone includes its own animation data. The other part is skin covered on the skeleton, e.g., grid model. The grid model is used to provide geometric model and texture material information which are both necessary for animation protraction. The character animation may be achieved by performing animation simulation for the skeleton, and then controlling skin deformation utilizing bones.

Because it is not necessary for boned animation to store vertex data of each frame, instead it is only necessary to store bones of each frame (number of the bones is relatively small). The same animation may be shared by multiple different skins by using the same bones. Therefore, the space occupied by the boned animation is quite small.

In several 3D graphics applications (e.g., 3D network games), selecting and controlling a character are achieved by PICK technologies. The idea of the PICK technologies is as follows. Firstly, obtaining coordinates indicating a location in a screen where a mouse clicked, and then transforming the coordinates by using projection matrix and observation matrix to a light ripping into a scene, in which the light also passes viewpoint and the location clicked by the mouse, if the light intersects a triangle in a scene model, obtaining information about the intersected triangle. In existed 3D applications, PICK judgment is generally performed by taking the whole 3D character model as a smallest unit. If the character is picked, user will perform next step operation for the character.

However, the above-mentioned PICK method cannot perform precise control for a certain part of the character. For example, when it is hoped to click different body parts of a character (e.g., hands or foots), and the character will reflect differently (e.g., swing hands or walk). The above-mentioned method obviously cannot meet the requirements.

### SUMMARY

This section provides a general summary of the disclosure, and is not a comprehensive disclosure of its full scope or all of its features.

To solve the above-mentioned problem that the character animation PICK technologies cannot perform precise control for a character, embodiments of the present invention provides a method and system for controlling character animation.

The technical solution adopted by embodiments of the present invention to solve the above-mentioned problem is to provide a method for controlling character animation, in which the character animation includes at least two bones and skins corresponding to the bones, the method includes the following blocks.

(a) dividing the character animation into at least two parts, and setting an identification number for each part;

(b) establishing a mapping table comprising a corresponding relationship between the identification number and skin data of each part;

(c) picking skin data of an operation focus location in the character animation;

(d) querying the mapping table according to the skin data, obtaining a corresponding identification number, and controlling the part in the character animation corresponding to the identification number.

Embodiments of the present invention also provide a system for controlling character animation, in which the character animation includes at least two bones and skins corresponding to the bones, the system includes:

a character division unit, configured to divide the character animation into at least two parts, and set an identification number for each part;

a mapping table establishment unit, configured to establish a mapping table, which comprises a corresponding relationship between the identification number and skin data of each part;

a character pick unit, configured to pick the skin data of an operation focus location in the character animation; and

a pick calculation unit, configured to query the mapping table according to the skin data, obtain corresponding identification number and controlling the part in the character animation corresponding to the identification number.

The method and system for controlling character animation provided by embodiments of the present invention, may pick different parts of a character animation by dividing the character animation into multiple parts. Consequently, precise control of an animation may be achieved, and actions of character animation may be enriched.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating structure of a system for controlling character animation in accordance with a first embodiment of the present invention describing the system;

FIG. 2 is a schematic diagram illustrating structure of a system for controlling character animation in accordance with a second embodiment of the present invention describing the system;

FIG. 3 is a flow chart illustrating a method for controlling character animation in accordance with an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In accordance with embodiments of the present invention, character animation is divided into several small parts during production, and character animation of each divided small parts is taken as the smallest unit for PICK calculation, consequently, the requirements of precise control for character animation may be achieved.

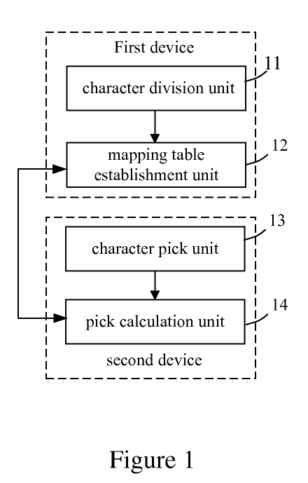

FIG. 1 is a schematic diagram illustrating structure of a system for controlling character animation in accordance with the first embodiment of the present invention describing the system. The character animation refers to character, animal or still image in a scene of three-dimensional. Each character animation is composed of multiple bones. Surface of each bone is covered by skin. The skin will perform corresponding action based on action of corresponding bone. In the embodiment, the system includes a character division unit 11, a mapping table establishment unit 12, a character pick unit 13 and a pick calculation unit 14. The character division unit 11 and the mapping table establishment unit 12 are located in a first device, e.g., a device for designing and developing animation. The character pick unit 13 and the pick calculation unit 14 are located in a second device, e.g., a device for playing the animation. Of course, in practical applications, the first device and the second device may be the same device as well.

The character division unit 11 is configured to divide the character animation into at least two parts, and set an identification number for each part. Generally, the character division unit 11 divides the character animation based on bone data. In the embodiment, the character division unit 11 performs the division based on activity characteristics of each part of the character animation. For example, if the character animation is an animal image of three-dimensional, the animal image may be divided into head, limbs, torso and so on. Each part of the character animation divided by the character division unit 11 corresponds to different bones.

The mapping table establishment unit 12 is configured to establish a mapping table. The mapping table includes a corresponding relationship between identification number denoted each part divided from the character animation and skin data of each part, i.e., the corresponding relationship between skin data and divided part.

The character pick unit 13 is configured to pick skin data of designated location of the character animation. Similar to the existed solution, the character pick unit 13 firstly obtains coordinates of an operation focus location (generally the location where the mouse clicks) in a screen, and then transforms the coordinates by using projection matrix and observation matrix to a light ripping into a scene, in which the light also passes viewpoint and the location clicked by the mouse. If the light intersects a triangle (e.g., the skin) in the scene model, obtaining the intersected triangle (generally the skin is composed of multiple triangles).

The pick calculation unit 14 is configured to query the mapping table established by the mapping table establishment unit 12 according to the skin data obtained by the character pick unit 13, so as to obtain the part where the above-mentioned skin data located in the character animation, that is, to obtain a corresponding identification number. If the part where the skin data located in the character animation may be obtained, precise control for the part of the character animation may be achieved.

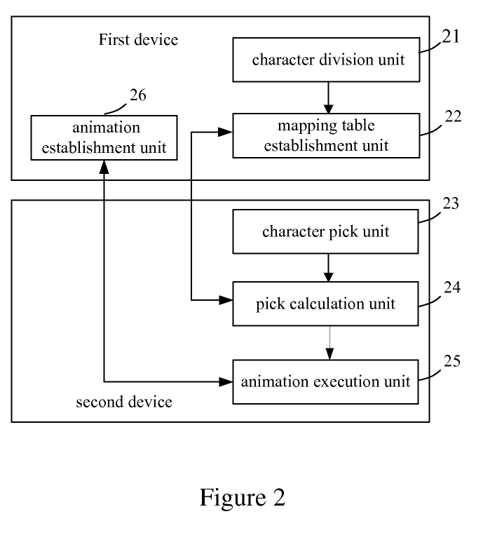

FIG. 2 is a schematic diagram illustrating structure of a system for controlling character animation in accordance with the second embodiment of the present invention describing the system. In the embodiment, the system includes an animation establishment unit 26 located in a first device in addition to a character division unit 21, a mapping table establishment unit 22, a character pick unit 23 and a pick calculation unit 24.

The animation establishment unit 26 is configured to establish a data table, which includes animation data of picked character animation part corresponding to each identification number. For example, if the head of the character animation is picked, the animation data of the character animation may be defined as swinging heads. If the limbs of the character animation are picked, the animation data of the character animation may be defined as jump, etc.

In addition, the system may still include an animation execution unit 25 located in a second device. The animation execution unit 25 is configured to query the data table established by the animation establishment unit 26 according to the identification number obtained by the pick calculation unit 24, and configured to execute corresponding animation data, such that the character animation may perform corresponding actions.

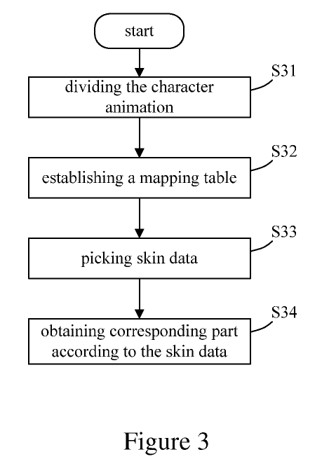

FIG. 3 is a flow chart illustrating a method for controlling character animation in accordance with a first embodiment of the present invention describing the method. The character animation refers to character, animal or still image in a scene of three-dimensional. Each character animation is composed of multiple bones. Surface of each bone is covered by skin. The skin may perform corresponding action based on action of corresponding bone. The method includes the following specific steps.

Step S31: dividing the character animation into at least two parts, and setting an identification number for each part. In the embodiment, dividing the character animation according to activity characteristics of each part of the character animation. For example, if the character animation is an animal image of three-dimensional, the animal image may be divided into head, limbs, torso, etc. Each part divided from the character animation corresponds to different bones.

Step S32: establishing a mapping table which includes a corresponding relationship between the identification number and skin data of each part, e.g., a corresponding relationship between the skin data and divided part.

Step S33: picking the skin data of the character animation of an operation focus location. The process of picking may adopt existed solution: firstly obtaining screen coordinates of a designated location (generally the location where the mouse clicks), and then transforming the coordinates by using projection matrix and observation matrix to a light ripping into a scene, in which the light also passes a viewpoint and the above-mentioned designated location. If the light intersects a triangle (i.e., skin) in a scene model, obtaining the intersected triangle (generally the skin is composed of multiple triangles).

Step S34: querying the mapping table established in S22 according to the skin data obtained in S33, so as to obtain corresponding identification number, that is, the part where the skin data located. Consequently, precise control for the part of the character animation or the whole character animation may be achieved.

In a second embodiment of the present invention describing the method for controlling character animation, in addition to the above-mentioned steps, the method still includes: establishing a data table which includes animation data of each selected part in a character animation corresponding to each identification number. In the data table, different actions are defined for different parts, and consequently, actions of character animation may be enriched.

In addition, the above method may still include: querying the data table according to the identification number obtained in S34, obtaining and executing animation data of a part corresponding to the identification number. Consequently, the character animation may perform corresponding action.

In accordance with the character animation controlling solution provided by embodiments of the present invention, the character animation is divided into multiple parts, and an identifier is set for each part, so as to pick different parts of the character animation, and consequently, precise control for each part in the character animation may be achieved. Besides, corresponding animation data is established for each divided part, such that actions of character animation may be enriched.

The foregoing description is only preferred embodiments of the present invention and is not used for limiting the protection scope thereof. All the modifications or substitutions within the technical scope disclosed by the invention, and easily occurred to those people with ordinary skill in the art shall be included in the protection scope of the present invention. Therefore, the protection scope of the invention should be determined based on the appended claims.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for controlling character animation, wherein the character animation comprises at least two bones and skins corresponding to the bones, the method comprises:
(a) dividing the character animation into at least two parts, and setting an identification number for each part;
(b) establishing a mapping table comprising a corresponding relationship between the identification number and skin data of each part;
(c) picking skin data of an operation focus location in the character animation;
(d) querying the mapping table according to the skin data, obtaining a corresponding identification number, and controlling the part in the character animation corresponding to the identification number.

2. The method according to claim 1, wherein in step (a) each part of the character animation corresponds to different bones.

3. The method according to claim 1, after step (a) further comprising:
(e) setting up a data table, which comprises animation data of each selected part in the character animation corresponding to each identification number.

4. The method according to claim 3, after step (d), further comprising:
(f) querying the data table according to obtained corresponding identification number, and executing corresponding animation data.

5. The method according to claim 2, after step (a) further comprising:
(e) setting up a data table, which comprises animation data of each selected part in the character animation corresponding to each identification number.

6. The method according to claim 5, after step (d), further comprising:
(f) querying the data table according to obtained corresponding identification number, and executing corresponding animation data.

7. The method according to claim 1, wherein the operation focus location in step (c) comprises a location in the character animation where a mouse clicked.

8. A system for controlling character animation, wherein the character animation comprises at least two bones and skins corresponding to the bones, the system comprises:
a character division unit, configured to divide the character animation into at least two parts, and set an identification number for each part;
a mapping table establishment unit, configured to establish a mapping table, which comprises a corresponding relationship between the identification number and skin data of each part;
a character pick unit, configured to pick the skin data of an operation focus location in the character animation; and
a pick calculation unit, configured to query the mapping table according to the skin data, obtain corresponding identification number and controlling the part in the character animation corresponding to the identification number.

9. The system according to claim 8, wherein each part of the character animation divided by the character division unit corresponds to different bones.

10. The system according to claim 8, further comprising:
an animation establishment unit, configured to establish a data table, which comprises animation data of selected part in the character animation corresponding to each identification number.

11. The system according to claim 10, further comprising:
an animation execution unit, configured to query the data table established by the animation establishment unit according to the identification number obtained by the pick calculation unit, and execute corresponding animation data.

12. The system according to claim 9, further comprising:
an animation establishment unit, configured to establish a data table, which comprises animation data of selected part in the character animation corresponding to each identification number.

13. The system according to claim 12, further comprising:
an animation execution unit, configured to query the data table established by the animation establishment unit according to the identification number obtained by the pick calculation unit, and execute corresponding animation data.

14. The system according to claim 8, wherein the operation focus location picked by the character pick unit comprises the location in the character animation where the mouse clicked.
